(19) United States
(12) Patent Application Publication
(10) Pub. No.: US 2015/0109200 A1
(43) Pub. Date: Apr. 23, 2015

(54) IDENTIFYING GESTURES CORRESPONDING TO FUNCTIONS

(71) Applicant: Samsung Electronics Co., Ltd., Gyeonggi-do (KR)

(72) Inventors: Yong-Suk LEE, Seoul (KR); Tae-Ho KANG, Gyeonggi-do (KR); Sung-Woo CHOI, Seoul (KR)

(21) Appl. No.: 14/489,617

(22) Filed: Sep. 18, 2014

(30) Foreign Application Priority Data
Oct. 21, 2013 (KR) 10-2013-0125129

(51) Int. Cl. G06F 3/01

(52) U.S. Cl. CPC G06F 3/017
USPC 345/156

(57) ABSTRACT

Disclosed herein are a method, electronic device, and non-transitory computer readable medium for detecting gestures. A head gesture is detected. It is identified whether the head gesture corresponds to a function based at least partially on an image pattern, an angular velocity pattern, and an acceleration pattern of the head gesture. The function corresponding to the head gesture is performed, when the head gesture corresponds to a function.

### CLAIM OF PRIORITY

This application claims priority under 35 U.S.C. §119 to an application filed in the Korean Intellectual Property Office on Oct. 21, 2013 and assigned Serial No. 10-2013-0125129, the contents of which are incorporated herein by reference.

### BACKGROUND

1. Technical Field

Various examples of the present disclosure relate generally to a method of operating a user interface of an electronic device.

2. Description of the Related Art

Recent developments in multimedia technology have led to the emergence of electronic devices with various functions. Conventional electronic devices may be mobile terminals referred to as “smart phones.” Such mobile terminals may include a large-screen touch type display module and a high-pixel camera module in addition to fundamental telecommunication functions; thus, today's devices allow users to capture still and moving images. Also, today's devices are capable of playing multimedia content such as music and video and connecting to a network for browsing the Internet. Thus, a high-performance processor may be included in order to perform various functions at high speeds. These devices may also be used as wearable devices attachable to a user's body.

### SUMMARY

A conventional wearable device uses face recognition method for recognizing a head gesture. But, the method has a lot of calculation amount, falls accuracy, and can not process quick recognition, because the method is dependent on only the video signal. In view of the foregoing problems, an aspect of the present disclosure provides an accurate and intuitive user interface by detecting a head gesture. The present disclosure provides a user interface that shortens the time needed for processing user input on an electronic device and decreases power consumption.

In one aspect of the present disclosure, a method may comprise: detecting a head gesture; identifying whether the head gesture corresponds to a function based at least partially on an image pattern, an angular velocity pattern, and an acceleration pattern of the head gesture; and performing the function corresponding to the head gesture, when the head gesture corresponds to a function

In another aspect of the present disclosure, an electronic device may include: an image sensor; a gyro sensor; an acceleration sensor; at least one processor to: detect a head gesture using the image sensor; identify whether the head gesture corresponds to a reference gesture based at least partially on an image pattern of the head gesture detected by the image sensor, an angular velocity pattern of the head gesture detected by the gyro sensor, and an acceleration pattern of the head gesture detected by the acceleration sensor; and perform a function corresponding to the reference gesture, when the head gesture corresponds to the reference gesture.

In yet another aspect, a non-transitory computer readable medium is provided. Upon execution, the instructions stored in the non-transitory computer readable medium may instruct at least one processor to: detect a head gesture; identify whether the head gesture corresponds to a reference gesture based at least partially on an image pattern of the head gesture, an angular velocity pattern of the head gesture, and an acceleration pattern of the head gesture; and perform a function corresponding to the reference gesture, when the head gesture corresponds to the reference gesture.

### BRIEF DESCRIPTION OF THE DRAWINGS

The above and other aspects, features and advantages of the present disclosure will become more apparent from the following detailed description when taken in conjunction with the accompanying drawings in which:

FIG. 1 is a block diagram of an example electronic device in accordance with aspects of the present disclosure;

FIG. 2 is a block diagram of an example processor in accordance with aspects of the present disclosure;

FIG. 3A, FIG. 3B and FIG. 3C show working examples of head gestures in accordance with aspects of the present disclosure;

FIG. 4A and FIG. 4B are example tables indicating pattern information of a head gesture in accordance with aspects of the preset disclosure;

FIG. 5 is a flow chart of an example method in accordance with aspects of the present disclosure;

FIG. 6 is a flow chart of a further example method in accordance with aspects of the present disclosure; and

FIG. 7 is a flow chart of yet another method in accordance with aspects of the present disclosure.

### DETAILED DESCRIPTION

Examples of the present disclosure are described below in detail with reference to the accompanying drawings. In describing the following examples, details of known functions or configurations are omitted so as not to obscure the subject matter of the present disclosure.

Although the present disclosure makes reference to portable electronic devices, it is understood that the techniques disclosed herein are not so limited. For example, the electronic device may include various wearable devices that may be installed on a portion of a user body, such as a PDA, an earphone, a headset, a headphone, smart glasses, a necklace, a hat, an earring, a watch, a camera, a navigation device, an MP3 player or a head mount device.

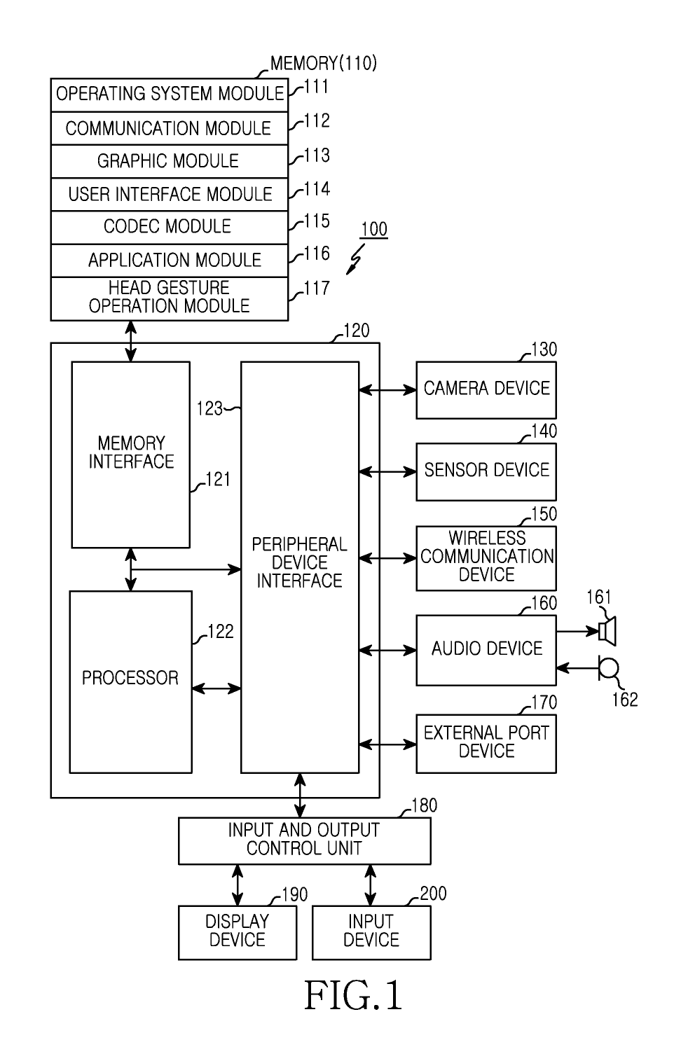

Referring to FIG. 1, electronic device 100 may include, but is not limited to, various devices such as a PDA, a laptop computer, a mobile phone, a smart phone, a handheld computer, a mobile internet device (MID), a media player, a ultra mobile PC (UMPC), a tablet PC, a note PC, a wrist watch, a navigation device, an MP3 player, a camera device or a wearable device. Also, the electronic device 100 may also be any device that includes a device combining two or more functions of such devices.

The components of electronic device 100 may include, but are not limited to, a memory 110, a processor unit 120, a camera device 130, a sensor device 140, a wireless communication device 150, an audio device 160, an external port device 170, an input and output control unit 180, a display device 190 and an input device 200. Although only one memory and processor is shown, it is understood that multiple memories and processors working in tandem may be employed. It is also understood that the plurality of memories and processors may be distributed and shared across multiple devices.

The processor unit 120 may include, but is not limited to, a memory interface 121, at least one processor 122, and a peripheral device interface 123. In this example, the memory interface 121, the at least one processor 122, and the peripheral device interface 123 that are included in the processor unit 120 may be in at least one integrated circuit or may be implemented as separate components.

The memory interface 121 may control an access of components such as a processor 122 or a peripheral device interface 123 to the memory. The peripheral device interface 123 may control a connection among the input and output peripheral device of the electronic device 100 and the processor 122 and the memory interface 121.

The processor 122 uses at least one software program to enable the electronic device 100 to provide various multimedia services. The processor 122 may execute at least one program stored in the memory 110 and provide a service corresponding to that program. The processor 122 may execute many software programs to perform many functions for the electronic device 100 and perform processing and control for voice communication, video communication and data communication. In addition, the processor 122 may perform the method of examples of the present disclosure in conjunction with software modules stored in the memory 110.

The processor 122 may include, but is not limited to, one or more data processors, an image processor, or a coder-decoder (CODEC). Moreover, the electronic device 100 may separately configure the data processor, the image processor or the CODEC.

Various components of the electronic device 100 may be connected through one or more communication buses (without a reference numeral) or electrical connection units (without a reference numeral).

The camera device 130 may perform camera functions such as picture or video clip capturing or recording. The camera device 130 may include, but is not limited to, a charged coupled device (CCD) or complementary metal-oxide semiconductor (CMOS). In addition, the camera device 130 may adjust a change in hardware configuration, such as lens movement, or number of irises, in accordance with a camera program executed by the processor 122.

The camera device 130 may provide the processor unit 120 with images obtained through capturing a subject. The camera device 130 may include, but is not limited to, an image sensor converting an optical signal into an electrical signal, an image signal processor converting an analog image signal into a digital image signal, and a digital signal processor processing an image signal output from an image processing device to enable the image signal to be displayed on the display device 190. Although not shown, the camera device 130 may include, but is not limited to, an actuator operating lenses and a driver IC driving the actuator.

The sensor device 140 may include, but is not limited to, a proximity sensor, a hall sensor, an illumination sensor, or a motion sensor. For example, the proximity sensor may sense an aspect approaching the electronic device 100 and the hall sensor may sense the magnetism of a metal. Also, the illumination sensor may sense light around the electronic device 100 and the motion sensor may include, but is not limited to, a gyro sensor or acceleration sensor that senses the movement of the electronic device 100. However, the present disclosure is not limited thereto, and the sensor device 140 may further include various sensors for implementing other known further functions.

The wireless communication device 150 enables wireless communication and may include, but is not limited to, a radio frequency (RF) transmitter and receiver or an optical (e.g., infrared) transmitter and receiver. Although not shown, the wireless communication device 150 may include, but is not limited to, an RF IC unit and a baseband processing unit. The RF IC unit may transmit and receive electromagnetic waves, convert a baseband signal from the baseband processing unit into an electromagnetic wave and provide the electromagnetic wave through an antenna.

The RF IC unit may include, but is not limited to, an RF transceiver, an amplifier, a tuner, an oscillator, a digital signal processor, a CODEC chip set, and a subscriber identification module (SIM) card.

The wireless communication device 150 may be implemented to operate through at least one of a GSM network, an EDGE network, a CDMA network, W-CDMA network, an LTE network, an OFDMA network, a Wi-Fi network, a WiMAX network, an NFC network, an infrared communication network, and a Bluetooth network, in accordance with a communication network. However, the present disclosure is not limited thereto, and the wireless communication device 150 may employ many communication techniques using a protocol for an e-mail, an instant messaging or short message service (SMS).

The audio device 160 is connected to a speaker 161 and a microphone 162 and may perform audio input and output functions such as voice recognition, voice copy, and digital recording or call functions. The audio device 160 may provide an audio interface between a user and the electronic device 100, convert a data signal received from the processor 122 into an electrical signal, and output the electrical signal through the speaker 161.

The speaker 161 may convert and output the electrical signal into an audible frequency band, and be arranged on the front or rear surface of the electronic device 100. The speaker 161 may include, but is not limited to, a flexible film speaker that is formed by attaching at least one piezoelectric unit to one vibration film.

The microphone 162 may convert a sound wave delivered from a human being or other sound sources into an electrical signal. The audio device 160 may receive the electrical signal from the microphone 162, convert a received electrical signal into an audio data signal, and transmit the audio data signal to the processor 122. The audio device 160 may include, but is not limited to, an earphone, an ear set, a head phone or a head set that may be attached and detached to and from the electronic device 100.

The external port device 170 may connect the electronic device 100 to another electronic device directly or indirectly through a network (e.g., an internet, an intranet, or a wireless LAN). The external port device 170 may include, but is not limited to, an USB port or a FIREWIRE port.

The input and output control unit 180 may provide an interface between input and output devices, such as a display device 190 and an input device 200, and the peripheral device interface 123. The input and output control unit 180 may include, but is not limited to, a display device controller and other input device controllers.

The display device 190 may provide an input and output interface between the electronic device 100 and a user. The display device 190 may employ a touch sensing technology, deliver user's touch information to the processor 122 and show visual information provided from the processor 122, such as a text, a graphic, or a video to the user.

The display device 190 may display state information on the electronic apparatus 100, texts input by the user, moving pictures and still pictures. In addition, the display device 190 may display information related to an application executed by the processor 122. Such a display device 190 may include, but is not limited to, at least one of a liquid crystal display (LCD), an organic light-emitting diode (OLED), an active matrix OLED (AMOLED), a thin film liquid crystal display (TFT-LCD), a flexible display and a 3D display.

The input device 200 may provide input data generated by user selection to the processor unit 122 through the input and output control unit 180. The input device 200 may include, but is not limited to, a key pad including at least one hardware button and a touch pad sensing touch information.

The input device 200 may include, but is not limited to, up/down buttons for controlling volume, and in addition, the input device 200 may include, but is not limited to, at least one of pointer devices that include a push button, a locker button, a locker switch, a thumb-wheel, a dial, a stick, a mouse, a trackball and a stylus that have corresponding functions.

The memory 110 may include, but is not limited to, a high-speed random access memories such as one or more magnetic disk storage devices, non-volatile memories, one or more optical storage devices or flash memories (for example, a NAND or NOR memory).

The memory 110 stores software which may include an operating system (OS) module 111, a communication module 112, a graphic module 113, a user interface module 114, a CODEC module 115, an application module 116 and a head gesture operation module 117. The term module is also represented as a set of instructions, an instruction set, or a program.

The OS module 111 may include, but is not limited to, an internal OS such as WINDOWS, LINUX, Darwin, RTXC, UNIX, OS X, Android, or VxWorks and include many software components that control general system operations. The control of such general system operations may mean memory control and management, storage hardware (device) control and management, power control and management, etc. In addition, the OS module 111 may perform a function of making the communication between many hardware pieces (devices) and software components (modules) smooth.

The communication module 112 may enable communication with an opposite electronic device such as a computer, a server, and an electronic device, through the wireless communication device 150 or the external port device 170.

The graphic module 113 may include, but is not limited to, many software components for providing and displaying graphics on the display device 190. The term graphic may indicate a text, a web page, an icon, a digital image, a video or animation.

The user interface module 114 may include, but is not limited to, many software components related to a user interface. The user interface module 114 may be configured to display information related to an application executed by the processor 122 on the display device 190. Also, the user interface module 114 may include, but is not limited to, details of how the state of the user interface is changed or under which condition the state of the user interface is changed.

The codec module 115 may include, but is not limited to, a software component related to encoding and decoding a video file. The application module 116 may include, but is not limited to, a software component related to at least one application that is installed in the electronic device 100. The application may include, but is not limited to, browser, email, phonebook, game, short message service, multimedia message service, social network service (SNS), instant message, wake-up call, MP3 player, scheduler, painting board, camera, word processing, keyboard emulation, music player, address book, contact list, widget, digital right management (DRM), voice recognition, voice copy and position determining functions, a location based service, or a user authentication service. The term application is also represented as an application program.

The head gesture operation module 117 may include, but is not limited to, various components for detecting a head gesture. The head gesture operation module 117 may identify whether a head gesture corresponds to an image pattern detected by an image sensor, an angular velocity pattern detected by a gyro sensor, and an acceleration pattern detected by an acceleration sensor. The image, angular velocity, and acceleration patterns may be predefined. Also, the head gesture operation module 117 may determine whether the image pattern, the angular velocity pattern, and the acceleration pattern that are described above corresponds to a reference image pattern, a reference angular velocity pattern, and a reference acceleration pattern.

Various functions of the electronic device 100 may be executed by software hardware that includes one or more processing or application specific ICs (ASICs).

Although not shown, the electronic device 100 may include a power system that supplies power to many components included in the electronic device 100. The power system may include, but is not limited to, a power supply (AC power supply or battery), a power error detection circuit, a power converter, a power inverter, a charging device, or a power state indicating device (light-emitting diode). In addition, the electronic device 100 may include a power management and control device that performs the functions of generating, managing and supplying power.

The foregoing components of the electronic device are merely illustrative and it is understood that some components may be removed or added. In the event that electronic device 100 is implemented as a wearable device, its components may be flexibly configured.

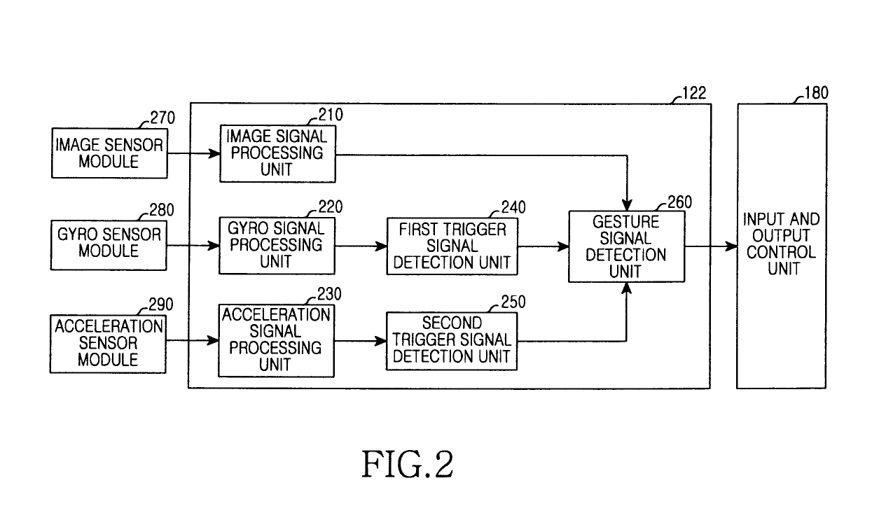

FIG. 2 is a block diagram of the processor 122 in accordance with aspects of the present disclosure.

Referring to FIG. 2, the processor 122 may include, but is not limited to, an image signal processing unit 210, a gyro signal processing unit 220, an acceleration signal processing unit 230, a first trigger signal detection unit 240, a second trigger signal detection unit 250, and a gesture signal detection unit 260. For example, the gyro signal processing unit 220 and the acceleration signal processing unit 230 may be configured in a module, in which case the first trigger signal detection unit 240 and the second trigger signal detection unit 250 may also be configured in a module.

In one example, the components of the processor 122 may be implemented in separate modules but in another example, they may also be included as software components in one module.

The image signal processing unit 210 may receive pieces of image information (or image patterns) from an image sensor module 270 and generate image signals. For example, the image signal processing unit 210 may determine whether an obtained image pattern corresponds to a preset reference image pattern.

The image signal processing unit 210 may include, but is not limited to, at least one software component for extracting an image of a user's appearance obtained through the image sensor module 270. For example, the image signal processing unit 210 may extract the location of a user's eyes from an image of a user's face obtained through the image sensor module 270. The image signal processing unit 210 may estimate a user's face motion based at least partially on a change in the location of the user's eyes.

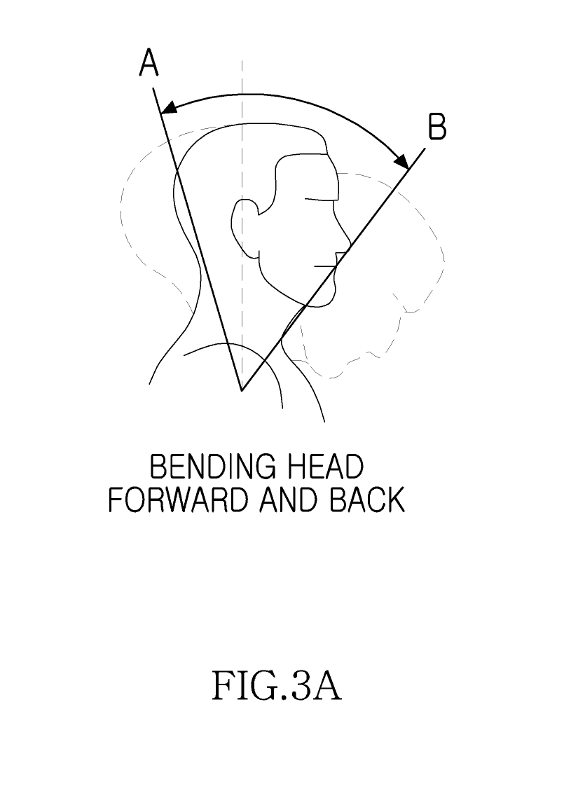

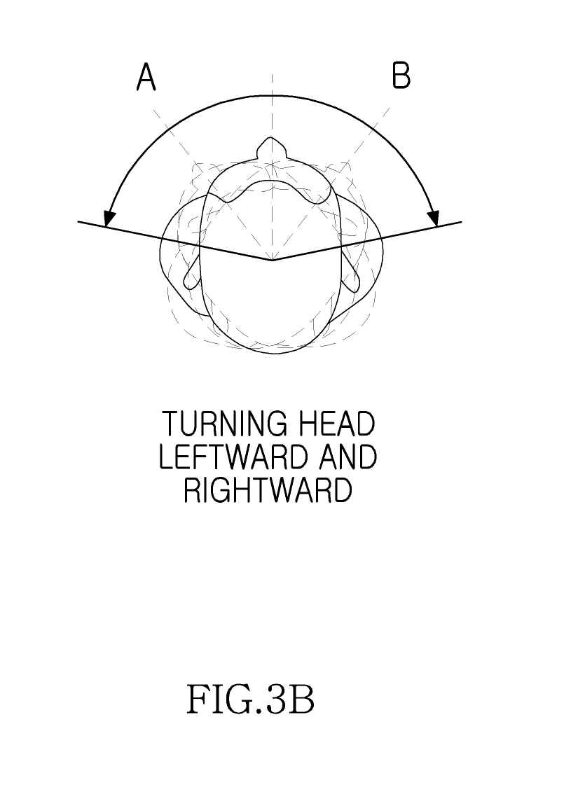

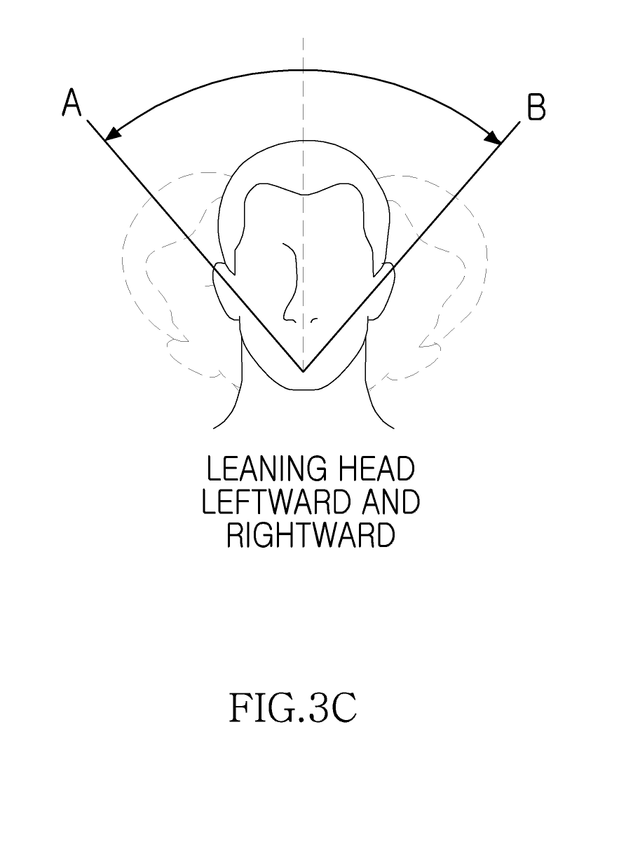

The image signal processing unit 210 may extract at least one characteristic or attribute from an image of a user's appearance obtained through the image sensor module 270. The image signal processing unit 210 may estimate a user's head motion based at least partially on a change in at least one characteristic of the image. In this example, the face motions may include, but are not limited to, a forward/back bending motion as shown in FIG. 3A, a left/right turning motion as shown in FIG. 3B, and a leaning left/right motion as shown in FIG. 3C.

In this example, the image signal processing unit 210 may estimate an image of the entire face by using only a portion of a face, when it is possible to obtain only a portion of a user's face through the image sensor module 270. For example, the image signal processing unit 210 may compare another image of a user's face stored in the memory 110 with an image of a portion of a user's face obtained through the image sensor module 270 to estimate an image of the entire face. As another example, the image signal processing unit 210 may also estimate an image of the entire face in consideration of the shape and size of a face detected from an image of a portion of a user's face obtained through the image sensor module 270.

In yet another example, the image signal processing unit 210 may also authenticate a user or estimate the age bracket of a user, through face recognition from an image obtained through the image sensor module 270. The image signal processing unit 210 may extract a face region by using information on brightness, motions, colors and eye location on an image obtained through the image sensor module 270 and detect characteristics of a face such as eyes, nose and mouth included in the face region. Then, the image signal processing unit 210 may compare the location and size of the characteristics of the image and the distance between the characteristics with reference images stored in the memory 110 and authenticate a user or estimate the age bracket of the user.

The image signal processing unit 210 may obtain information on the focus of image data in addition to the image data through the image sensor module 270. For example, the image signal processing unit 210 may identify a presence or absence of the focus of an image pattern obtained through the image sensor module 270, at a first time, a second time and a third time. The image signal processing unit 210 may identify the presence or absence of the focus based on the presence of a stored reference focus at a first time, a second time and a third time.

The electronic device 100 may identify through such focus information whether a head gesture of a user is not intended head gesture or an intended head gesture. However, the present disclosure is not so limited and the electronic device 100 may use various pieces of image information.

The gyro signal processing unit 220 may receive angular velocity pattern information on the head gesture of a user from a gyro sensor module 280 and generate a gyro signal.

The gyro signal processing unit 220 may extract a change in angular velocity on the head gesture of a user, such as bending a head forward/back as shown in FIG. 3A, turning a head left/right as shown in FIG. 3B, and leaning a head left/right as shown in FIG. 3C. The gyro signal processing unit 220 may compare such angular velocity pattern information with a reference angular velocity pattern stored in the memory 110 and determine whether an obtained angular velocity pattern corresponds to a predefined reference angular velocity pattern.

The acceleration signal processing unit 230 may receive acceleration pattern information on the head gesture of a user from an acceleration sensor module 290 and generate an acceleration signal.

The acceleration signal processing unit 230 may extract a change in acceleration on the head gesture of a user, such as motions bending a head forward/back as shown in FIG. 3A, motions turning a head left/right as shown in FIG. 3B, and motions leaning a head left/right as shown in FIG. 3C. The acceleration signal processing unit 230 may compare such acceleration pattern information with a reference acceleration pattern stored in the memory 110 and identify whether an obtained acceleration pattern corresponds to a predefined reference acceleration pattern.

The first trigger signal detection unit 240 may detect a first trigger signal corresponding to a head gesture from a gyro signal that is generated by the gyro signal processing unit 220. Wherein, the trigger signal may mean a signal that gives operation opportunity or start to a circuit. The first trigger signal detection unit 240 may provide the first trigger signal detected to the gesture signal detection unit 260.

The second trigger signal detection unit 250 may detect a second trigger signal corresponding to a head gesture from an acceleration signal that is generated by the acceleration signal processing unit 230. The second trigger signal detection unit 250 may provide the second trigger signal detected to the gesture signal detection unit 260.

The gesture signal detection unit 260 may use the first trigger signal and the second trigger signal provided from the first trigger signal detection unit 240 and the second trigger signal detection unit 250 to set a gesture signal detection region in pattern of head gesture and detect a corresponding gesture signal from the set gesture signal detection region. Also, through such a method, it is also possible to detect an end signal for finishing detection gesture signal That is, the gesture signal detection unit 260 may control the detection start and end of the gesture signal through the trigger signal and the end signal that are obtained.

In one example, the gesture signal detection unit 260 may use a plurality of signals provided from individual modules or an individual signal to detect a gesture signal. In addition, the gesture signal detection unit 260 may create a control command corresponding to a gesture recognition result and the control command through the input and output control unit 180.

In this example, the angular velocity sensor, the acceleration sensor, and the acceleration pattern may be symmetrically arranged on the electronic device to accurately detect the head gesture of a user. For example, in the case of electronic glasses, the angular velocity sensor and the acceleration sensor may be installed on each of left and right temples. In this case, the electronic device 100 may obtain more accurate information on angular velocity and acceleration in comparison to when one angular velocity sensor and one acceleration sensor are installed. However, the symmetrical arrangement may be in accordance with the structure and shape of the particular device.

It is understood that processor 122 may have more or less components than those shown in the example of FIG. 2.

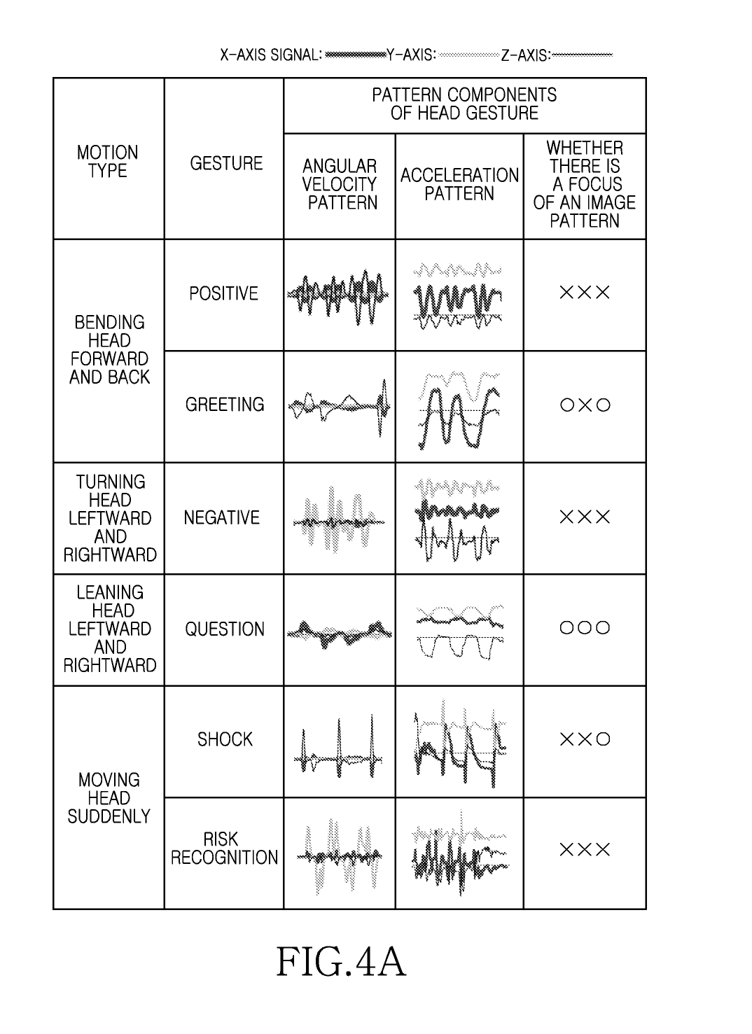

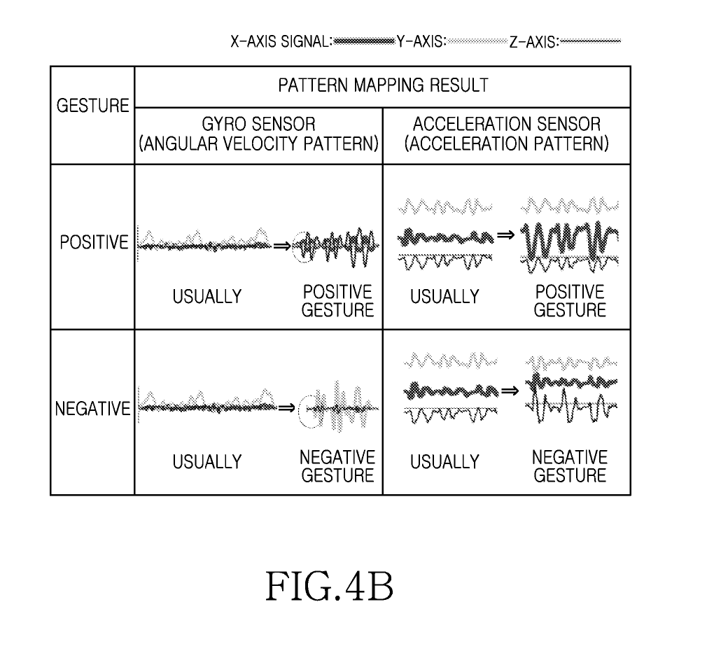

FIGS. 4A and 4B are example tables that illustrate head pattern data in accordance with aspects of the preset disclosure. Referring to FIG. 4A, the electronic device 100 may use each piece of pattern information of a user's motion to detect a corresponding gesture.

The electronic device 100 may recognize a user's head gesture such as bending a head forward/back as shown in FIG. 3A and may determine an angular velocity pattern, an acceleration pattern, an image pattern, or the presence or absence of the image pattern. In this case, the electronic device 100 may recognize through a pattern mapping result as shown in FIG. 4B whether the head gesture of a user means a positive response or a greeting.

Referring to FIG. 4B, the electronic device 100 may recognize a user's positive gesture through an angular velocity pattern received from the gyro sensor and an acceleration pattern received from the acceleration sensor. For example, when a user performs a positive gesture, an angular velocity pattern signal for the positive gesture has large amplitude in the Z-axis and shows a sinusoidal pattern. Also, X-axis and Y-axis signals do not exceed the amplitude of the Z-axis signal and may show a sine waveform starting from −180°. In addition, an acceleration pattern signal for the positive gesture has large amplitude in X-axis and may also have a negative number.

Also, when a user performs a negative gesture, an angular velocity pattern signal for the negative gesture has large amplitude in Y-axis and shows a sinusoidal pattern. Also, X-axis and Y-axis signals do not exceed the amplitude of the Y-axis signal. In addition, an acceleration pattern signal for the negative gesture has large amplitude in Z-axis and may also have a negative number.

As described above, the electronic device 100 may obtain pattern information on the head gesture of a user and recognize the intention of that gesture in such a manner that such pattern information is mapped to a stored pattern signal. In addition, the electronic device 100 may determine whether there is a focus on obtained image information and determine whether it corresponds to a reference focus. For example, the electronic device 100 may determine whether the presence or absence of the focus of an image pattern at a first time, a second time and a third time corresponds to the presence of a reference focus at a first time, a second time and a third time. That is, when a user moves his or her head up or down as shown in FIG. 3A, the presence and absence of a focus of an image pattern will vary depending on a head gesture when meaning a positive response and a head gesture when providing a greeting. Thus, the electronic device 100 may identify the intention of the head gesture through various pieces of pattern information as described above.

FIG. 4A are graphs representative of bending a head forward/back as shown in FIG. 3A, motions turning a head left/right as shown in FIG. 3B, and motions leaning a head left/right as shown in FIG. 3C. However, in addition to the above-described motions, various motions may be represented accordingly. Also, the predefined reference patterns may vary depending on a user's unique characteristics, and it is possible to determine when a predefined reference pattern matches pattern information of a head gesture at a certain rate.

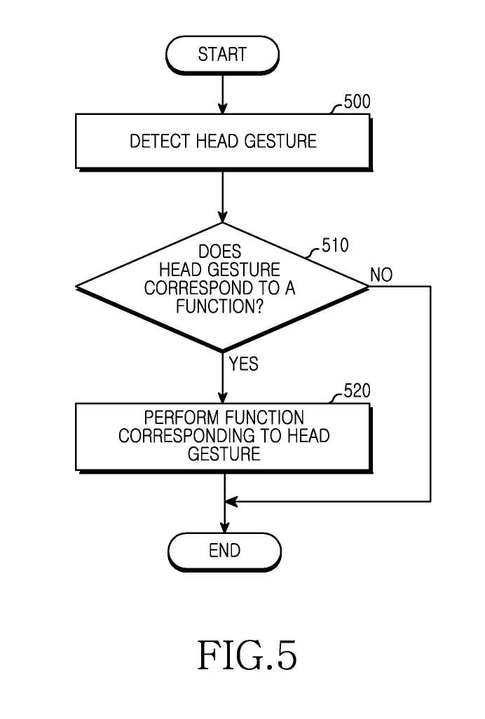

Referring now to the example method of FIG. 5, the electronic device 100 may detect the head gesture in operation 500. In this example, the head gesture may include motions bending a head forward/back as shown in FIG. 3A, motions turning a head leftward/rightward as shown in FIG. 3B, and motions leaning a head leftward/rightward as shown in FIG. 3C.

In one example, the electronic device 100 may obtain an image pattern, an angular velocity pattern and an acceleration pattern on the head gesture through an image sensor, a gyro sensor and an acceleration sensor.

The image signal processing unit 210 of the electronic device 100 may receive pieces of image information (or image patterns) from the image sensor module 270 and generate image signals. For example, the image signal processing unit 210 may determine whether an obtained image pattern corresponds to a predefined reference image pattern.

As noted above, the image signal processing unit 210 may include, but is not limited to, at least one software component for extracting an image of a user's appearance obtained through the image sensor module 270. For example, the image signal processing unit 210 may extract the location of a user's eyes from an image of a user's face obtained through the image sensor module 270. The image signal processing unit 210 may estimate a user's face motion based at least partially on a change in the location of the user's eyes.

As also discussed above, the image signal processing unit 210 may extract at least one characteristic or attribute from an image of a user's appearance obtained through the image sensor module 270. The image signal processing unit 210 may estimate a user's head motion based at least partially on a change in at least one characteristic of the image. In this example, the face motions may include, but are not limited to, a forward/back bending motion as shown in FIG. 3A, a left/right turning motion as shown in FIG. 3B, and a leaning left/right motion as shown in FIG. 3C.

In this example, the image signal processing unit 210 may estimate an image of the entire face by using only a portion of a face, when it is possible to obtain only a portion of a user's face through the image sensor module 270. For example, the image signal processing unit 210 may compare another image of a user's face stored in the memory 110 with an image of a portion of a user's face obtained through the image sensor module 270 to estimate an image of the entire face. As another example, the image signal processing unit 210 may also estimate an image of the entire face in consideration of the shape and size of a face detected from an image of a portion of a user's face obtained through the image sensor module 270.

In yet another example, the image signal processing unit 210 may also authenticate a user or estimate the age bracket of a user, through face recognition from an image obtained through the image sensor module 270. The image signal processing unit 210 may extract a face region by using information on brightness, motions, colors and eye location on an image obtained through the image sensor module 270 and detect characteristics of a face such as eyes, nose and mouth included in the face region. Then, the image signal processing unit 210 may compare the location and size of the characteristics of the image and the distance between the characteristics with reference images stored in the memory 110 and authenticate a user or estimate the age bracket of the user.

The image signal processing unit 210 may obtain information on the focus of image data in addition to the image data through the image sensor module 270. For example, the image signal processing unit 210 may identify a presence or absence of the focus of an image pattern obtained through the image sensor module 270, at a first time, a second time and a third time. The image signal processing unit 210 may identify the presence or absence of the focus based on the presence of a stored reference focus at a first time, a second time and a third time.

The electronic device 100 may identify through such focus information whether a head gesture of a user is an intuitive head gesture or an intended head gesture. However, the present disclosure is not so limited and the electronic device 100 may use various pieces of image information.

The gyro signal processing unit 220 may receive angular velocity pattern information on the head gesture of a user from a gyro sensor module 280 and generate a gyro signal.

The gyro signal processing unit 220 may extract a change in angular velocity on the head gesture of a user, such as bending a head forward/back as shown in FIG. 3A, turning a head left/right as shown in FIG. 3B, and leaning a head left/right as shown in FIG. 3C. The gyro signal processing unit 220 may compare such angular velocity pattern information with a reference angular velocity pattern stored in the memory 110 and determine whether an obtained angular velocity pattern corresponds to a predefined reference angular velocity pattern.

The acceleration signal processing unit 230 may receive acceleration pattern information on the head gesture of a user from an acceleration sensor module 290 and generate an acceleration signal.

The acceleration signal processing unit 230 may extract a change in acceleration on the head gesture of a user, such as motions bending a head forward/back as shown in FIG. 3A, motions turning a head left/right as shown in FIG. 3B, and motions leaning a head left/right as shown in FIG. 3C. The acceleration signal processing unit 230 may compare such acceleration pattern information with a reference acceleration pattern stored in the memory 110 and identify whether an obtained acceleration pattern corresponds to a predefined reference acceleration pattern.

Referring back to FIG. 5, the electronic device 100 may identify whether the head gesture corresponds to a function in operation 510. In one example, electronic device 100 may identify whether the head gesture maps to a reference head gesture. In turn, electronic device 100 may then identify whether the reference head gesture corresponds to a function.

In one example, the electronic device 100 may compare the pattern information of the head gesture to reference mapping information, such as the reference mapping information shown in FIG. 4A, to identify whether there is a correspondence therebetween.

Referring back to FIG. 5, when the head gesture corresponds to a function, the electronic device 100 may perform a function corresponding to the head gesture in operation 520. For example, the electronic device 100 may operate a user interface corresponding to a reference gesture that maps to the head gesture or input a command corresponding to the head gesture.

The present examples make reference to the motion patterns of bending a head forward/back as shown in FIG. 3A, motions turning a head left/right as shown in FIG. 3B, and motions leaning a head left/right as shown in FIG. 3C. However, it is understood that other motions may be analyzed and compared to other reference motion patterns.

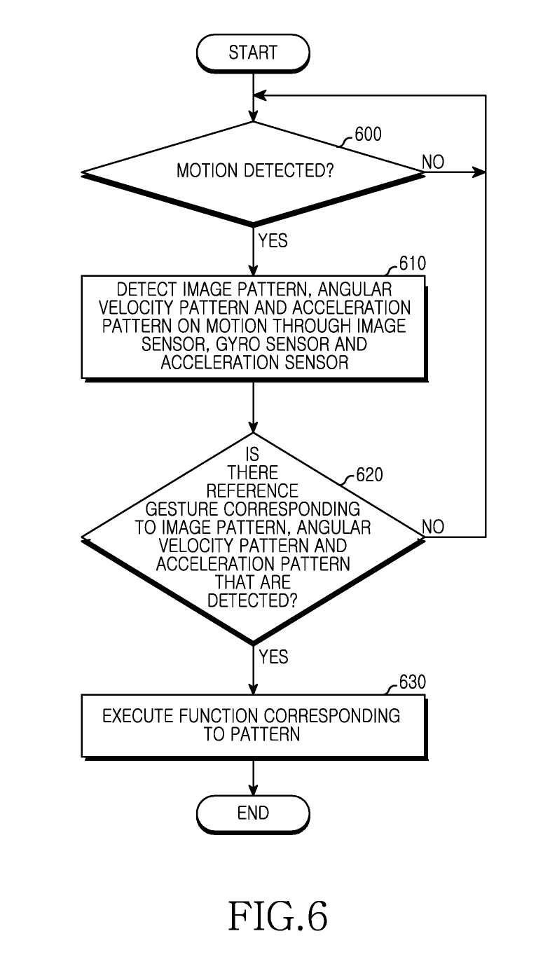

Referring to the example method shown in FIG. 6, the electronic device 100 may determine whether a motion of the electronic device is detected, in operation 600. For example, the electronic device 100 may sense the shaking of the electronic device 100 through an acceleration sensor or a gyro sensor.

When the motion is detected, electronic device 100 may detect an image pattern, an angular velocity pattern and an acceleration pattern of the detected motion through an image sensor, the gyro sensor and the acceleration sensor at operation 610.

At operation 620, the electronic device 100 may determine whether there is a reference gesture corresponding to the image pattern, the angular velocity pattern and the acceleration pattern that was detected. Electronic device 100 may compare the detected motion patterns with reference patterns, such as those illustrated in FIG. 4A, to determine whether there is a correspondence therebetween. When a reference pattern corresponds to the detected angular velocity pattern and acceleration pattern, electronic device 100 may execute a function or operation corresponding to the patterns.

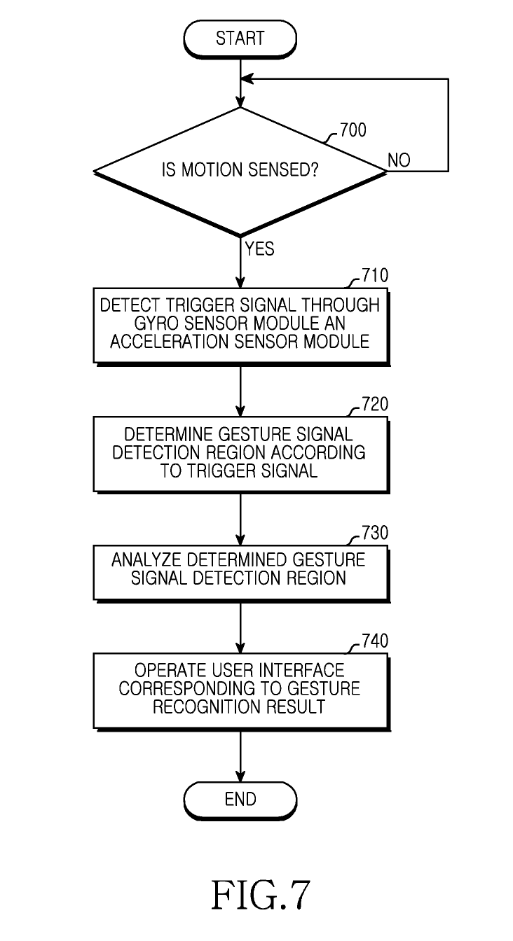

Referring now to the example method of FIG. 7, the electronic device 100 may determine whether a motion is sensed in operation 700. For example, the electronic device 100 may sense the shaking of the electronic device 100 through an acceleration sensor or a gyro sensor.

At operation 710, electronic device 100 may detect a trigger signal through a gyro sensor module and an acceleration sensor module. In one example, when a predefined pattern of a trigger signal matches an input pattern signal, the electronic device 100 may detect the trigger signal and detect a gesture signal that follows. At operation 720, the electronic device 100 may determine a gesture signal detection region in accordance with the trigger signal. Electronic device 100 may use the trigger signal to set a gesture signal detection region in pattern of head gesture.

At operation 730, electronic device 100 may analyze a determined gesture signal detection region. Since the electronic device 100 analyzes only the determined gesture signal detection region in this example, the total number of signals to be processed decreases and processing is enhanced. Also, it is possible to identify whether a gesture signal is not intended gesture or an intended gesture, in accordance with whether image data is in focus.

At operation 740, the electronic device 100 may operate a function corresponding to the gesture in operation 740. For example, the electronic device 100 may input a command corresponding to a reference gesture.

In another example, the electronic device 100 may perform various functions based on voice patterns or other gesture inputs in addition to head gestures.

A set of commands or functions corresponding to the motion patterns may be stored as one or more modules in the above-described memory 110. In this instance, the modules stored in the memory 110 may be executed by one or more processors 122.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

In addition, an artisan understands and appreciates that a “processor” or “microprocessor” constitute hardware in the claimed invention. Under the broadest reasonable interpretation, the appended claims constitute statutory subject matter in compliance with 35 U.S.C. §101. The functions and process steps herein may be performed automatically or wholly or partially in response to user command. An activity (including a step) performed automatically is performed in response to executable instruction or device operation without user direct initiation of the activity.

The terms “unit” or “module” referred to herein is to be understood as comprising hardware such as a processor or microprocessor configured for a certain desired functionality, or a non-transitory medium comprising machine executable code, in accordance with statutory subject matter under 35 U.S.C. §101 and does not constitute software per se.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims Furthermore, while particular processes are shown in a specific order in the appended drawings, such processes are not limited to any particular order unless such order is expressly set forth herein; rather, processes may be performed in a different order or concurrently and steps may be added or omitted.

What is claimed is:

1. A method in an electronic device, the method comprising:
detecting a head gesture;
identifying whether the head gesture corresponds to a function based at least partially on an image pattern, an angular velocity pattern, and an acceleration pattern of the head gesture; and
performing the function corresponding to the head gesture, when the head gesture corresponds to the function.

2. The method of claim 1, wherein identifying whether the head gesture corresponds to the function further comprises identifying a presence or absence of a focus of the image pattern of the head gesture at a first time, a second time and a third time.

3. The method of claim 1, wherein the head gesture is detected through a gyro sensor and an acceleration sensor symmetrically installed on the electronic device.

4. The method of claim 1, wherein the electronic device is placed on a portion of a body of a user.

5. The method of claim 1, wherein at least one of the image pattern, the angular velocity pattern, and the acceleration pattern is preset.

6. The method of claim 1, wherein identifying whether the head gesture corresponds to the function further comprises detecting whether the head gesture corresponds to a trigger signal.

7. The method of claim 6, further comprising determining a gesture detection region in accordance with the trigger signal.

8. The method of claim 7, further comprising analyzing the gesture detection region and inputting a command corresponding to a gesture recognition result.

9. An electronic device comprising:
an image sensor;
a gyro sensor;
an acceleration sensor;
at least one processor to:
detect a head gesture using the image sensor;
identify whether the head gesture corresponds to a reference gesture based at least partially on an image pattern of the head gesture detected by the image sensor, an angular velocity pattern of the head gesture detected by the gyro sensor, and an acceleration pattern of the head gesture detected by the acceleration sensor; and
perform a function corresponding to the reference gesture, when the head gesture corresponds to the reference gesture.

10. The electronic device of claim 9, wherein, to identify whether the head gesture corresponds to the reference gesture, the at least one processor to further identify a presence or absence of a focus of the image pattern using the image sensor at a first time, a second time and a third time.

11. The electronic device of claim 9, wherein the image sensor, the gyro sensor, and the acceleration sensor are symmetrically installed on the electronic device.

12. The electronic device of claim 9, wherein the electronic device is placed on a portion of a body of a user.

13. The electronic device of claim 9, wherein the at least one processor to predefine at least one of a reference image pattern, a reference angular velocity pattern, and a reference acceleration pattern.

14. The electronic device of claim 9, wherein the processor to detect a trigger for the head gesture when it is determined that the head gesture corresponds to the reference gesture.

15. The electronic device of claim 14, wherein the processor to identify a gesture detection region in accordance with the trigger.

16. The electronic device of claim 15, wherein the processor to analyze the gesture detection region and input a command corresponding to a gesture recognition result.

17. A non-transitory computer readable medium which upon execution instructs at least one processor to:
detect a head gesture;
identify whether the head gesture corresponds to a reference gesture based at least partially on an image pattern of the head gesture, an angular velocity pattern of the head gesture, and an acceleration pattern of the head gesture; and
perform a function corresponding to the reference gesture, when the head gesture corresponds to the reference gesture.
